(19) United States
(12) Patent Application Publication
(10) Pub. No.: US 2025/0260452 A1
(43) Pub. Date: Aug. 14, 2025

(54) EARLY CSI REPORTING DURING RACH PROCEDURE

(71) Applicant: APPLE INC., Cupertino, CA (US)

(72) Inventors: Haitong Sun, Cupertino, CA (US); Wei Zeng, San Diego, CA (US); Yushu Zhang, Beijing (CN); Chunxuan Ye, San Diego, CA (US); Jie Cui, San Jose, CA (US); Dawei Zhang, Saratoga, CA (US); Weidong Yang, San Diego, CA (US)

(21) Appl. No.: 18/857,999

(22) PCT Filed: Apr. 27, 2022
(86) PCT No.: PCT/CN2022/089558

§ 371 Date: Oct. 18, 2024

(51) Int. Cl. H04B 7/06; H04W 24/10; H04W 74/0833

(52) U.S. Cl. CPC H04B 7/0626; H04W 24/10; H04W 74/0833

(57) ABSTRACT

The disclosure relates to supporting early CSI reporting during a RACH procedure. In some embodiments, there is provided a user equipment (UE), comprising: at least one antenna; at least one radio coupled to the at least one antenna; and a processor coupled to the at least one radio; wherein the UE is configured to perform operations comprising: receiving from a base station a trigger for triggering reporting of CSI during a RACH procedure; and reporting, to the base station, CSI during the RACH procedure.

### TECHNICAL FIELD

This application relates generally to wireless communication systems, including user equipments, base stations, methods, apparatus, and medium for supporting early CSI report during a RACH procedure.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

Embodiments relate to user equipments, base stations, methods, apparatus, and medium for supporting early CSI report during a RACH procedure.

According to the techniques described herein, early CSI reporting during a RACH procedure is supported. A user equipment (UE) may report, to a base station, CSI during a RACH procedure. The UE may report CSI in Msg3 for a 4-step RACH procedure, report CSI in MsgA for a 2-step RACH procedure, or report CSI in Msg3 during a fallback operation for a 2-step RACH procedure.

In some embodiments, the UE may receive a trigger for triggering the early CSI reporting. The trigger may be included in System Information (SI) or Radio Resource Control (RRC) configuration, Medium Access Control (MAC) Control Element (CE), or Downlink Control Information (DCI).

In some embodiments, the UE may receive CSI report configuration from the base station. The CSI report configuration may comprise at least one of the following: (i) reference signal configuration used for CSI measurement, or (ii) report quantity configuration for CSI reporting.

In some embodiments, timeline strains are considered. The timeline strains may comprise a minimum time required for the UE to measure the CSI and generate a CSI report. In some embodiments, the timeline strains may additionally comprise a minimum time required for the UE to finish processing of the trigger.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A illustrates an example flowchart of 4-step Random Access Channel (RACH), according to embodiments disclosed herein.

FIG. 3B illustrates an example flowchart of 2-step RACH, according to embodiments disclosed herein.

FIG. 4A illustrates a MAC payload for Random Access Response (RAR) as defined in the prior art.

FIG. 4B illustrates contents of the 27 bits UL Grant as defined in the prior art.

FIG. 5A illustrates an example reference signal configuration, according to embodiments disclosed herein.

FIG. 5B illustrates another example reference signal configuration, according to embodiments disclosed herein.

FIG. 6 illustrates example minimum time constrains for 4-step RACH procedure or a fallback operation for 2-step RACH procedure, according to embodiments disclosed herein.

FIG. 7 illustrates a method performed by a UE, according to embodiments disclosed herein.

FIG. 8 illustrates a method performed by a base station, according to embodiments disclosed herein.

FIG. 9 illustrates a method performed by a UE, according to embodiments disclosed herein.

FIG. 10 illustrates a method performed by a base station, according to embodiments disclosed herein.

FIG. 11 illustrates a method performed by a UE, according to embodiments disclosed herein.

FIG. 12 illustrates a method performed by a base station, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

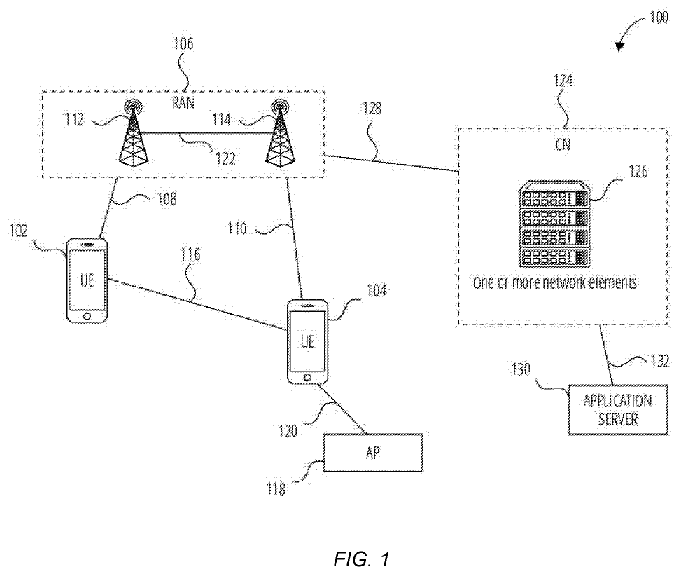

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR. In a case that the RAN 106 is an NTN-based NG-RAN architecture, the connection 108 and connection 110 are NR Uu interfaces.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

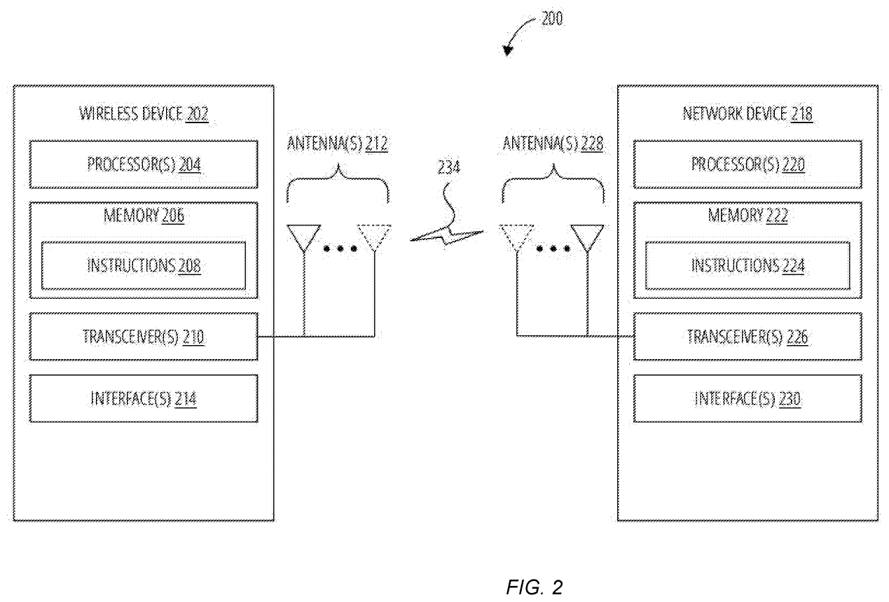

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Satellites maximize the inherent value of 5G networks by solving coverage problems and providing difficult use-cases that ground-based infrastructure alone cannot address. 5G standards make Non-Terrestrial Networks (NTNs)—including satellite segments-a recognized part of 5G connectivity infrastructure.

NTN is used to deliver 5G/NR service via space (satellite) or air (airborne platform) to those places where it is technically very difficult or cost too much to deliver with a terrestrial network (TN). Some examples of those places would be a remote area like deep forest that would be too costly with terrestrial delivery, or far islands or ships that would be technically almost forbidden in terrestrial connection.

In order to establish uplink synchronization and Radio Resource Control (RRC) connection between a UE and a base station (e.g., a gNB), the UE has to perform a Random Access Channel (RACH) random access procedure.

In current NR, two types of random access procedures are supported, including: (1) Type-1 random access procedure, i.e., 4-step RACH, and (2) Type-2 random access procedure, i.e., 2-step RACH. When 2-step RACH is failed, fallback to 4-step RACH is supported.

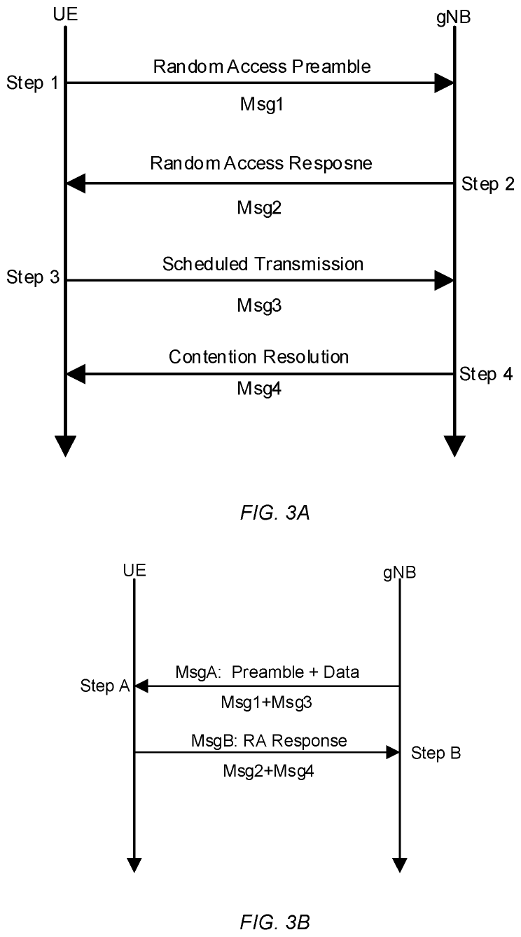

FIG. 3A illustrates an example flowchart of 4-step RACH, according to embodiments disclosed herein. As shown in FIG. 3A, the 4-step RACH comprises the following steps:
Step 1: A UE transmits to a gNB Msg1 (or a preamble). In particular, the UE transmits to the gNB a PRACH preamble, and then the UE monitors Type1-PDCCH CSS (Physical Downlink Control Channel Common Search Space) for DCI format 1_0 with Cyclic Redundancy Check (CRC) scrambled by a corresponding RA-RNTI;
Step 2: The gNB transmits to the UE Msg2 (or, Random Access Response (RAR)). In particular, the gNB responds to the UE transmitted the PRACH preamble by scheduling a RAR transmission in which UL grant is provided. UL grant is provided for scheduling the transmission of Msg3 by the UE.
Step 3: The UE transmits Msg3 according to the UL grant in RAR.
Step 4: The gNB transmits Msg4 after decoding Msg3.

FIG. 3B illustrates an example flowchart of 2-step RACH, according to embodiments disclosed herein.

As shown in FIG. 3B, the 2-step RACH comprises the following steps:

Step A: The UE transmits MsgA to the gNB. In particular, the UE transmits a PRACH preamble and data (PUSCH) in MsgA, and then UE monitors Type1-PDCCH CSS for DCI format 1_0 with CRC scrambled by a corresponding MsgB-RNTI. MsgA can be represented as combination of Msg1+Msg3.

Step B: The gNB transmits MsgB after decoding MsgA. In MsgB, UL grant is provided. MsgA can be represented as combination of Msg2+Msg4.

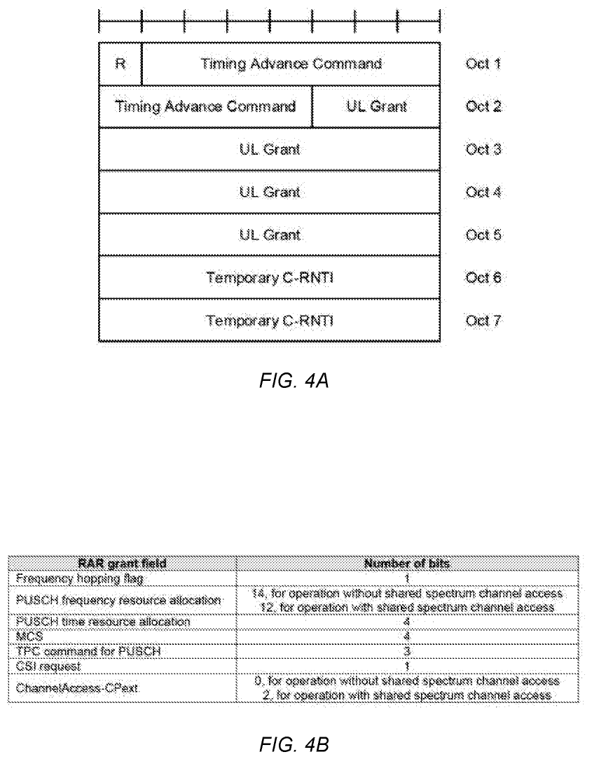

FIG. 4A illustrates a MAC payload for RAR as defined in the prior art. As can be seen, 27 bits UL Grant is a part of the RAR (Msg2) to schedule the transmission of Msg3 by the UE.

FIG. 4B illustrates contents of the 27 bits UL Grant as defined in the prior art. As shown in FIG. 4B, a “CSI request” field including 1 bit is provided. However, the “CSI request” field is reserved and useless. That is, how to use the “CSI request” field has not been defined.

Currently, early CSI reporting during a RACH procedure is not supported. However, in order to reduce latency of the RACH procedure, improve reliability of the RACH procedure and improve further communication, it is beneficial for UE to report CSI as early as possible.

For example, the early CSI reporting can be useful especially for FR2 (Frequency Range 2, i.e., mmWave) if the UE can update its preferred beam as early as possible.

The disclosure herein discusses that the UE may report CSI in Msg3 for Type 1 random access procedure, in MsgA for Type 2 random access procedure, or in Msg3 during a fallback operation for Type 2 random access procedure.

The disclosure herein also discusses triggering mechanism, reference signal configuration, report quantity consideration and timeline constrains for supporting early CSI reporting during a RACH procedure.

### Triggering Mechanism for 4-Step PRACH Procedure

For 4-step PRACH procedure, the CSI may be reported in Msg3.

In order to trigger CSI report in Msg3 for 4-step PRACH procedure, there may be several different triggering mechanisms.

In some embodiment, in order to resolve the backward compatibility issue, i.e., the reserved “CSI request” field in the UL grant provided in Msg2 (i.e., RAR message) (as shown in FIG. 4B) is useless, the gNB may inform the UE that the “CSI request” field in the UL grant is not reserved any more. The gNB may provide this information in System Information (S1) or RRC configuration.

A new field may be introduced into S1 (more particularly, e.g., SIB1) to indicate to the UE that the reserved “CSI request” field in the UL grant provided in Msg2 (i.e., RAR message) is used. The UE may determine whether to report CSI in Msg3 based on the bit value in the “CSI request” field. For example, bit “0” may indicate that the UE shall not report CSI in Msg3, while bit “1” may indicate that the UE shall report CSI in Msg3.

In some other embodiments, the gNB may configure in S1 or RRC configuration whether a UE shall report CSI in Msg3. A new field may be introduced into S1 or RRC configuration to indicate whether a UE shall report CSI in Msg3. In such a case, the UE determines whether to report CSI in Msg3 only based on the received S1 or RRC configuration, without the need to further refer to the reserved “CSI request” field in the UL grant in Msg2.

In some other embodiments, a new “CSI request” field may be introduced in the DCI format 1_0 with CRC scrambled by RA-RNTI in Type1-PDCCH CSS (Physical Downlink Control Channel Common Search Space). The newly introduced “CSI request” field may be used to trigger UE to report CSI in Msg3.

The newly introduced “CSI request” field may include 1 bit, wherein bit “0” indicates that the UE shall not report CSI in Msg3 while bit “1” indicates that the UE shall report CSI in Msg3.

The bitwidth of the newly introduced “CSI request” field may be more than 1. In such a case, the newly introduced “CSI request” field may also be used to indicate at least a part of CSI report configuration. For example, the newly introduced “CSI request” field may be used to indicate which CSI the UE should report.

In some other embodiments, the gNB may configure one or more PRACH resource pools associated with supporting of the early CSI reporting. In particular, the gNB may configure different PRACH resource pools for UEs. Some PRACH resource pools may include PRACH resources that can be used together with PUSCH with CSI reporting in Msg3 for new UEs supporting the early CSI reporting, while other PRACH resource pools may include PRACH resources that can be used as legacy way (i.e., no CSI reporting in Msg3) for legacy UEs not supporting the early CSI reporting.

The gNB may send S1 or RRC configuration to the UE including the different PRACH resource pools. A UE supporting the early CSI reporting selects/uses a PRACH resource from a PRACH resource pool associated with supporting of the early CSI reporting. The UE may send communication (e.g., Msg1 including the selected PRACH preamble) to the gNB using the selected PRACH resource.

In such a case, from the perspective of the UE, that the gNB provides a PRACH resource pool associated with supporting of the early CSI reporting indicates to the UE that the network supports early CSI reporting during a RACH procedure. From the perspective of the gNB, that the UE selects/uses a PRACH resource from the PRACH resource pool associated with supporting of the early CSI reporting means that the UE supports the early CSI reporting (e.g., in the case of reporting CSI in Mag3) or even that the UE has reported CSI during a RACH procedure (e.g., in the case of reporting CSI in MsgA).

In the case of reporting CSI in Msg3, the UE may determine to trigger the CSI reporting e.g., based on S1 or RRC configuration, or “CSI request” field in DCI format 1_0 or RAR MAC CE, and then report CSI in Msg3.

In some other embodiments, new MAC CE or new DCI may be introduced to carry CSI reporting trigger indication (e.g., a “CSI request” field) indicating whether the UE shall report CSI in Msg3.

### Triggering Mechanism for 2-Step PRACH Procedure

For 2-step PRACH procedure, the CSI may be reported in MsgA.

In some embodiments, the gNB may configure in S1 or RRC configuration whether a UE shall report CSI in MsgA. For example, a field including one or more bits may be introduced in S1 or RRC configuration to indicate whether a UE shall report CSI during a RACH procedure.

In some embodiments, S1 or RRC configuration may further comprise CSI report configuration, such as reference signal configuration used for CSI measurement and/or report quantity configuration for CSI reporting.

The UE may perform CSI measurement and CSI reporting based on the CSI report configuration upon determining to report CSI in MsgA based on the received S1 or RRC configuration.

In some other embodiments, the gNB may configure a PRACH resource pool associated with supporting of the early CSI reporting. In particular, the gNB may configure different PRACH resource pools for UEs. Some PRACH resource pools may include PRACH resources that can be used together with PUSCH with CSI reporting in MsgA for new UEs supporting the early CSI reporting, while other PRACH resource pools may include PRACH resources that can be used as legacy way (i.e., no CSI reporting in MsgA) for legacy UEs not supporting the early CSI reporting.

The gNB may send S1 or RRC configuration to the UE including the different PRACH resource pools. The UE supporting the early CSI reporting selects/uses a PRACH resource from a PRACH resource pool associated with supporting of the early CSI reporting and reports CSI in MsgA.

In such a case, from the perspective of the UE, that the gNB provides a PRACH resource pool associated with supporting of the early CSI reporting indicates to the UE that the network supports early CSI reporting during a RACH procedure. From the perspective of the gNB, that the UE selects/uses a PRACH resource from the PRACH resource pool associated with supporting of the early CSI reporting means that the UE supports the early CSI reporting and may report CSI in MsgA (including a PRACH preamble and data).

### Triggering Mechanism During a Fallback Operation for 2-Step PRACH Procedure

During the fallback operation for 2-step PRACH procedure, the CSI may be reported in Msg3. The triggering mechanisms for the fallback operation may be the similar as those for 4-step PRACH procedure.

In some embodiment, in order to resolve the backward compatibility issue, i.e., the reserved “CSI request” field in the UL grant provided in Fallback RAR message (which may contain the same information as the RAR for 4-step RACH) is useless, the gNB may inform the UE that the “CSI request” is not reserved any more in e.g., System Information (S1) or RRC configuration.

A new field may be introduced into S1, (more particularly, e.g., SIB1) to indicate to the UE that the reserved “CSI request” field in the UL grant provided in Fallback RAR message is used. The UE may determine whether to report CSI in Msg3 based on the bit value in the “CSI request” field in the UL grant. For example, bit “0” may indicate that the UE shall not report CSI in Msg3, while bit “1” may indicate that the UE shall report CSI in Msg3.

In some other embodiments, the gNB may configure in S1 or RRC configuration whether a UE shall report CSI in Msg3. One or more bits may be introduced into S1 or RRC configuration to indicate whether a UE shall report CSI in Msg3. In such a case, the UE determines whether to report CSI in Msg3 only based on the received S1 or RRC configuration, without the need to further refer to the reserved “CSI request” field in the UL grant provided in Fallback RAR message.

In some other embodiments, a new “CSI request” field may be introduced in the DCI format 1_0 with CRC scrambled by MsgB-RNTI in Type1-PDCCH CSS. When Fallback RAR MAC-CE is detected by the UE, the newly introduced “CSI request” field can trigger the UE to report CSI in Msg3.

The newly introduced “CSI request” field may include 1 bit, wherein bit “0” indicates that the UE shall not report CSI in Msg3 while bit “1” indicates that the UE shall report CSI in Msg3.

The bitwidth of the newly introduced “CSI request” field may be more than 1. In such a case, the newly introduced “CSI request” field may also be used to indicate at least a part of CSI report configuration. For example, the newly introduced “CSI request” field may be used to indicate which CSI UE should report.

In some other embodiments, the gNB may configure a PRACH resource pool associated with supporting of the early CSI reporting. In particular, the gNB may configure different PRACH resource pools for UEs. Some PRACH resource pools may include PRACH resources that can be used together with PUSCH with CSI reporting in Msg3 for new UEs supporting the early CSI reporting, while other PRACH resource pools may include PRACH resources that can be used as legacy way (i.e., no CSI reporting in Msg3) for legacy UEs not supporting the early CSI reporting.

The gNB may send S1 or RRC configuration to the UE, including the different PRACH resource pools. The UE supporting the early CSI reporting selects/uses a PRACH resource from the PRACH resource pool associated with supporting of the early CSI reporting. The UE may send communication (e.g., Msg1 including the selected PRACH preamble) to the gNB using the selected PRACH resource.

In such a case, the UE may determine to trigger the CSI reporting e.g., based on S1 or RRC configuration, or “CSI request” field in DCI format 1_0 or Fallback RAR MAC CE, the and then report SCI in Msg3.

In some other embodiments, new MAC CE or DCI may be introduced to carry CSI reporting trigger indication (e.g., a “CSI request” field) indicating whether the UE shall report CSI in Msg 3.

### Reference Signal Configuration

The reference signal for CSI measurement may be either Synchronization Signal and PBCH block (SSB) or Channel State Information Reference Signal (CSI-RS).

In some embodiments, for 4-step RACH procedure or a fallback operation for 2-step RACH procedure, the reference signal may be the reference signal (either CSI-RS or SSB) used to initiate the PRACH transmission.

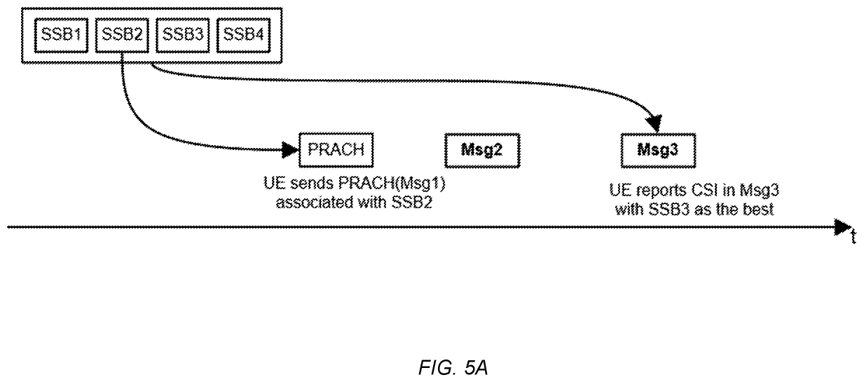

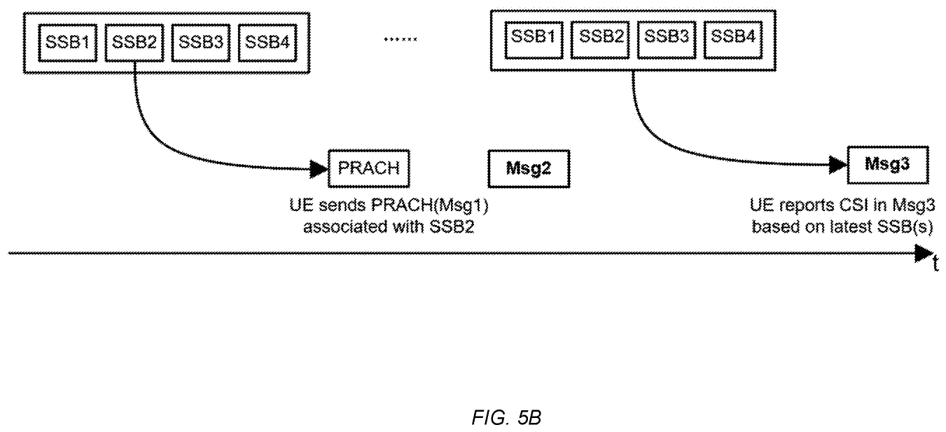

FIG. 5A illustrates an example reference signal configuration, according to embodiments disclosed herein.

As shown in FIG. 5A, the gNB uses SSB as the reference signal, and sends e.g., SSB1-SSB 4 in a burst, the UE may measure SSB 1-4 trying find which one can be used to send PRACH. In order to reduce latency, the UE may send PRACH on SSB 2 which is assumed first to be found as meeting quality requirements, even though SSB 3 may be the best if all SSB 1-4 have been measured. After the UE sends PRACH associated with SSB2 and before the UE sends Msg3, the UE may have finished measurement of all SSB 1-4 and determines SSB 3 is the best. Then in Msg3, the UE will report to the gNB SSB3 is the best in the CSI. In such a case, the SSB burst (SSB 1-4) including SSB 2 initiating the PRACH transmission is taken as the reference signal for CSI measurement.

FIG. 5B illustrates another example reference signal configuration, according to embodiments disclosed herein.

It is assumed that there is a long delay between PRACH (Msg 1) and Msg3. In such a case, the UE may initially generate a CSI report based on the SSB burst initiating the PRACH transmission, and then update the CSI report based on the latest or several latest observation of the same reference signal. That is, after the UE sent Msg 1 and before the UE sends Msg 3, the gNB may have sent a plurality of SSB bursts e.g., every 20 ms and the UE have finished measurement of the last SSB burst and thus it can report CSI in Msg3 based on the measurement of the last SSB burst or the measurement of the last several SSB bursts. As shown in FIG. 5B, the CSI reported in Msg3 may be generated or updated based on the last SSB burst. In such a case, the last SSB burst or the last several SSB bursts may be taken as the reference signal for CSI measurement.

In some other embodiments, reference signal other than the reference signal used to initiate the PRACH transmission can be separately configured for CSI measurement. This reference signal configuration can be done in S1 or RRC configuration.

For example, in addition to the reference signal used to initiate the PRACH transmission, the gNB can configure different/additional reference signals for CSI measurement, e.g., for beam refinement.

In some embodiments, only SSB may be used. In other embodiments, both SSB and CSI-RS can be used, but they cannot be mixed for the same CSI report. In other embodiments, both SSB and CSI-RS can be used, and they can be mixed for the same CSI report.

In some embodiments, only periodic signal can be used. In other embodiments, both periodic signal and aperiodic signal can be used, but all reference signals for the same CSI report shall have the same time domain behavior. That is, all reference signals for the same CSI report shall be either periodic or aperiodic.

In some embodiments, only 1-port reference signal can be used. In other embodiments, both 1-port reference signal and 2-port reference signal can be used, but all reference signals for the same CSI report shall have the same number of ports. In some embodiments, up to X port (X>=4) reference signal can be used, but all reference signals for the same CSI report shall have the same number of ports. For example, for CSI-RS, up to 32 ports can be supported. 1-port reference signals can be used to measure beams. 2-port reference signals can be used to measure beams and multiple layer transmission. Multiple-port reference signals with 4 ports or more than 4 ports can be used to measure Multiple-Input Multiple-Output (MIMO) layers.

### Report Quantity Configuration

Report quantity configuration include which reporting parameters shall be reported.

In some embodiments, when CSI can be report in Msg3 or 2-step RACH or 2-step RACH fallback operation, reporting quantity may include L1-RSRP. That is, the reporting quantity may include either cri-RSRP, or ssb-Index-RSRP, wherein cri-RSRP refers to CSI-RS resource indicator/index.

In some other embodiments, the reporting quantity may include L1-SINR. That is, the reporting quantity may include either cri-SINR-r16, or ssb-Index-SINR-r16.

In some other embodiments, the reporting quantity may include one or more of cri-RI-PMI-CQI, cri-RI-LI-PMI-CQI, cri-RI-il, cri-RI-il-CQI, or cri-RI-CQI, wherein RI refers to Rank Indicator, PMI refers to Precoding Matrix Indicator, CQI refers to Channel Quality Indicator and L1/i1 refers to layer indicator.

Those skilled in the art can understand that the reporting quantity may include one or more of the reporting parameters as mentioned above and may include any possible combination thereof.

In some embodiments, the reporting quantity can be Semi-statically configured by S1 or RRC configuration. In some other embodiments, the reporting quantity can be indicated by the “CSI request” field in either DCI or UL Grant (RAR MAC CE).

When L1-RSRP or L1-SINR is reported, the number of beams may be considered. In some embodiments, only 1 (best) beam will be reported. In some other embodiments, more than 1 beam can be reported, the number of beams to be reported can be indicated by “CSI request” field in either DCI or UL Grant (RAR MAC CE) or semi-statically configured by S1/RRC configuration.

When L1-RSRP or L1-SINR is reported, whether the reporting is group based may be considered. A group may include one or multiple pairs of beams, each pair contains two beams that UE can receive simultaneously. In some embodiments, no group-based reporting is supported. In some other embodiments, only group-based reporting is supported. In some other embodiments, toggling between group-based reporting and none-group-based reporting is supported, which may be indicated by “CSI request” field in either DCI or UL Grant (RAR MAC CE), or may be semi-statically configured by S1 or RRC configuration.

### Timeline Constrains

The CSI measurement and/or the CSI reporting may be performed based on timeline constrains. The timeline constrains as considered may include at least minimum time that is required for the UE to measure CSI and generate a CSI report (referred as minimum time T1 as below).

In some embodiments, the minimum time T1 may be a fixed value predetermined.

In some other embodiments, the minimum time T1 may be reported as UE capability. Before establishment of a RRC connection, different RACH resource pools may be used for reporting of UE capability. For example, in the case that a new PRACH resource pool associated with the early CSI reporting is configured, from the perspective of a gNB, that a UE uses a PRACH resource from the new PRACH resource pool means that the UE's capability meets the timeline constrain based on minimum time T1.

For 2 step RACH procedure, the minimum time T1 that is required for the UE to measure the CSI and generate the CSI report may be defined as the time from a starting point which is the end of the last reference signal for CSI measurement to an end point which is the first symbol of PUSCH that carries the CSI report.

For 4-step RACH procedure or a fallback operation for 2-step RACH procedure, in addition to the minimum time T1, another minimum time (referred as minimum time T2 as below) that required for the UE to finish processing of the CSI report trigger (e.g., “CSI request” field in MAC CE or in DCI) may also be considered.

Minimum time T2 may be defined as the time from a starting point to an end point. The end point may be the first symbol of PUSCH that carries CSI report. The starting point may be one of the following: (1) the last symbol of DCI that triggers the CSI report in Msg3; (2) the last symbol of PDSCH that carries MAC-CE that triggers the CSI report in Msg3 or (3) 3 ms after the HARQ-ACK in responds to the PDSCH that carries MAC-CE that triggers the CSI report in Msg3.

The CSI measurement and/or CSI reporting may be performed based on the timeline constrains, in addition to reference signal configuration and/or CSI report configuration.

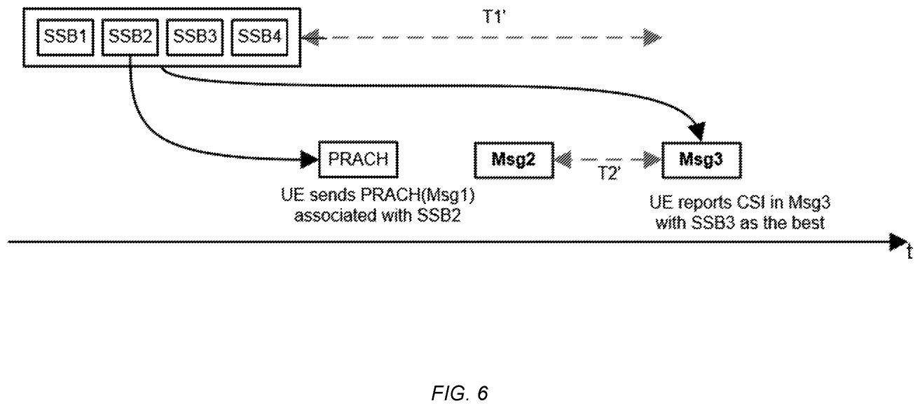

FIG. 6 illustrates example minimum timeline constrains for 4-step RACH procedure or a fallback operation for 2-step RACH procedure, according to embodiments disclosed herein.

As shown in FIG. 6, the time T1′ is computed from a starting point which is the end of the last reference signal for CSI measurement (i.e., the end of the SSB burst initiating the PRACH transmission in FIG. 6) to an end point which is the first symbol of PUSCH in Msg 3 that carries CSI report.

As shown in FIG. 6, time T2′ is computed from a starting point to an end point. The end point may be the first symbol of PUSCH in Msg 3 that carries CSI report. The starting point may be one of the following: (1) the last symbol of DCI in Msg 2 that triggers the CSI report in Msg3; (2) the last symbol of PDSCH in Msg 2 that carries MAC-CE that triggers the CSI report in Msg3 or (3) 3 ms after the HARQ-ACK in responds to the PDSCH in Msg 2 that carries MAC-CE that triggers the CSI report in Msg3.

For the UE, T1′ and T2′ shall meet the timeline constrains including minimum time T1 and minimum time T2.

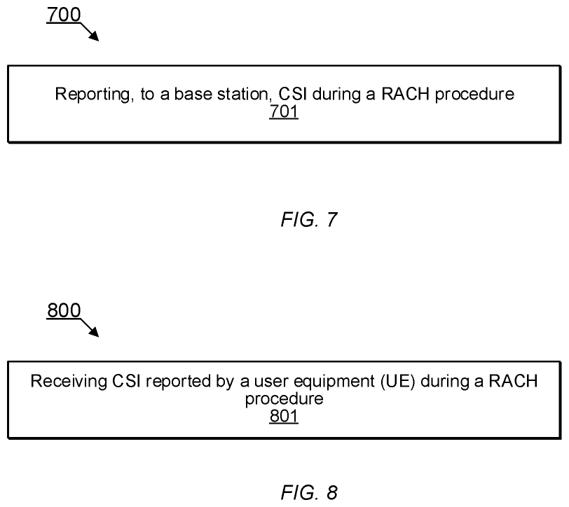

FIG. 7 illustrates a method 700 performed by a UE, according to embodiments disclosed herein.

As shown in FIG. 7, the method 700 comprises operation 701, where the UE reports, to a base station, CSI during a RACH procedure.

The UE may report CSI in Msg3 for a 4-step RACH procedure, report CSI in MsgA for a 2-step RACH procedure; or report CSI in Msg3 during a fallback operation for a 2-step RACH procedure.

FIG. 8 illustrates a method 800 performed by a base station, according to embodiments disclosed herein.

As shown in FIG. 8, the method 800 comprises operation 801, where the base station receives CSI reported by a UE during a RACH procedure.

The CSI may be received in Msg3 for a 2-step RACH procedure or during a fallback operation for a 2-step RACH procedure. The base station may receive the CSI in MsgA for a 2-step RACH procedure.

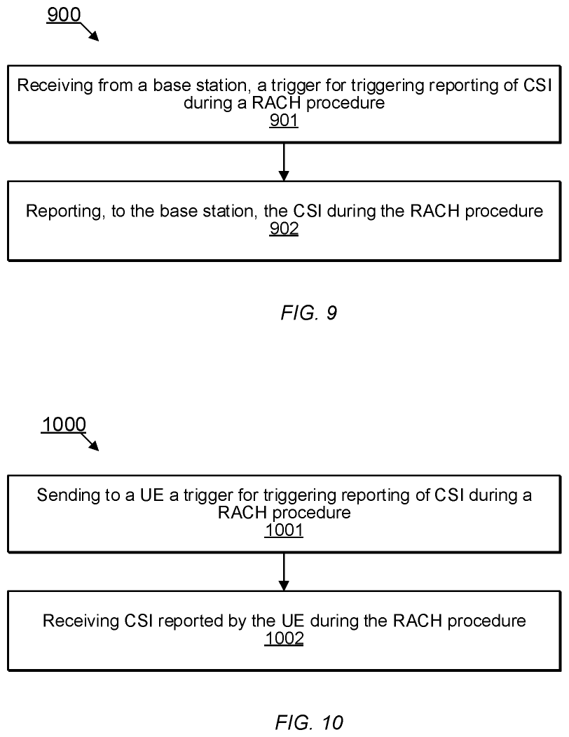

FIG. 9 illustrates a method 900 performed by a UE, according to embodiments disclosed herein.

As shown in FIG. 9, the method 900 comprises operation 901, where the UE receives, from a base station, a trigger for triggering reporting of CSI during a RACH procedure.

The trigger may be one or more bits that can be used to trigger the UE to make early CSI reporting. For example, one bit with value of “1” may be used as the trigger.

More specifically, the trigger may be used to indicate that the UE shall report CSI in Msg3 for 4-step RACH procedure or a fallback operation for 2-step RACH procedure, or report CSI in MsgA for 2-step RACH procedure.

The trigger may be included in System Information (S1) or RRC configuration. One or more bits may be introduced into S1 or RRC configuration to indicate to the UE whether to trigger early CSI reporting. More specifically, the trigger included in S1 or RRC configuration indicates to the UE that the UE shall report CSI in Msg3 for 4-step RACH procedure or a fallback operation for 2-step RACH procedure, or report CSI in MsgA for 2-step RACH procedure.

The trigger may be included in MAC CE.

In some embodiments, a previously reversed “CSI request” field in RAR MAC CE (UL grant) may be used to indicate whether the early CSI reporting shall be done. For example, if the previously reversed “CSI request” field includes bit 1, it indicates that the UE shall report CSI during the RACH procedure. In such a case, one bit may be introduced in S1 or RRC configuration that the previously reversed “CSI request” field is not reserved anymore and the bit “1” in this “CSI request” field can be used as the trigger to trigger early CSI reporting at the UE.

In some other embodiments, the trigger may be included in newly introduced MAC CE.

The trigger may be included in DCI. A new “CSI request” field introduced into DCI format 1_0 may be used to indicate whether the early CSI reporting shall be done. For example, if the new “CSI request” field includes bit 1, it indicates that the UE shall report CSI during the RACH procedure. In some embodiments, more than one bit can be set in the new “CSI request” field to allow dynamic choice of CSI to be reported.

In some other embodiments, the trigger may be included in newly introduced DCI.

The method 900 comprises operation 902, where the UE reports to the base station, the CSI during the RACH procedure.

Operation 902 is similar as operation 701 in FIG. 7. Thus, detailed recitation of operation 902 is omitted.

FIG. 10 illustrates a method 1000 performed by a base station, according to embodiments disclosed herein.

As shown in FIG. 10, the method 1000 comprises operation 1001, where the base station sends to a UE a trigger for triggering reporting of CSI during a RACH procedure.

The method 1000 further comprises operation 1002, where the base station receives CSI reported by the UE during the RACH procedure.

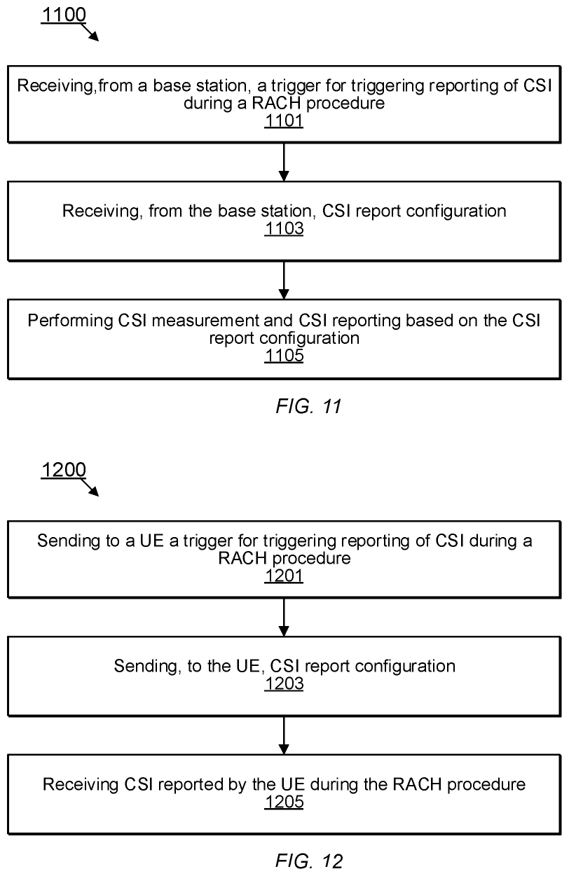

FIG. 11 illustrates a method 1100 performed by a UE, according to embodiments disclosed herein.

As shown in FIG. 11, the method 1100 comprises operation 1101, where the UE receives, from a base station, a trigger for triggering reporting of CSI during a RACH procedure.

The method 1100 further comprises operation 1103, where the UE receives, from the base station, CSI report configuration.

The CSI report configuration comprises at least one of the following: (i) reference signal configuration used for CSI measurement, or (ii) report quantity configuration for CSI reporting.

At least a part of the CSI report configuration may be included in one of the following: (i) System Information (S1) or RRC configuration; (ii) MAC CE; or (iii) DCI.

In some embodiments, the trigger and the CSI report configuration are included in S1 or RRC configuration. In some embodiments, the trigger and the CSI report configuration are included in MAC CE or DCI, e.g., in “CSI request field.”

The method 1100 further comprises operation 1105, where the UE performs CSI measurement and CSI reporting based on the CSI report configuration.

FIG. 12 illustrates a method 1200 performed by a base station, according to embodiments disclosed herein.

As shown in FIG. 12, the method 1200 comprises operation 1201, where the base station sends to a UE a trigger for triggering reporting of CSI during a RACH procedure.

The method 1200 further comprises operation 1203, where the UE sends, to the UE, CSI report configuration.

The base station may send the CSI report configuration in S1 or RRC configuration, MAC CE, or DCI.

The method 1200 further comprises operation 1205, where the base station receives CSI reported by the UE during the RACH procedure. The received CSI is obtained by the UE based on the CSI report configuration.

In some embodiments, for 2-step RACH procedure, the UE may receive from the base station, PRACH resource configuration in the S1 or the RRC configuration. The PRACH resource configuration may include available PRACH resources from a PRACH resource pool associated with supporting of the reporting of CSI during a RACH procedure. The UE may select a PRACH resource from the available PRACH resources and send MsgA by using the selected PRACH resource. The sent MsgA includes CSI report and selected PRACH preamble. In such a case, from the perspective of UE, that the gNB configures available PRACH resources from a PRACH resource pool associated with supporting of the reporting of CSI during a RACH procedure is an implied trigger of early CSI reporting at the UE. From the perspective of gNB, the UE uses a PRACH resource selected from the available PRACH resources indicates that MsgA sent by the UE MAY include an early CSI report. In such a case, the CSI report configuration may be included in the S1 or the RRC configuration.

In some embodiments, for 4-step RACH procedure or a fallback operation for 2-step RACH procedure, the UE may receive from the base station, PRACH resource configuration in the S1 or RRC configuration, the PRACH resource configuration includes available PRACH resources from a PRACH resource pool associated with supporting of the reporting of CSI during a RACH procedure. The UE may select a PRACH resource from the available PRACH resources and send Msg1 by using the selected PRACH resource.

In such a case, as an example, the trigger and CSI report configuration may also be included in the S1 or the RRC configuration. However, as another example, the trigger and CSI report configuration may also be included in MAC CE and/or DCI.

In some embodiments, timeline constrains are considered. The CSI measurement and/or CSI reporting may be performed based on the timeline constrains.

The timeline constrains may include at least a first minimum time required for the UE to measure the CSI and generate a CSI report. The first minimum time may be defined as the time from a starting point to an ending point, wherein the ending point is a first symbol of PUSCH that carries a CSI report, and the starting point is the end of a last reference signal for CSI measurement.

In some cases, the timeline constrains further include a second minimum time required for the UE to finish processing of the trigger. The second minimum time may be defined as the time from a starting point to an ending point, wherein the ending point may be a first symbol of PUSCH that carries a CSI report, and the starting point may be one of the following: (i) a last symbol of DCI format 1_0 that triggers the CSI report in Msg3; (ii) a last symbol of PDSCH that carries MAC-CE that triggers the CSI report in Msg3; or (iii) 3 ms after the HARQ-ACK in responds to the PDSCH that carries MAC-CE that triggers the CSI report in Msg3.

Embodiments contemplated herein include an apparatus comprising means to perform one or more elements of the method 700, 900 and 1100. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 700, 900 and 1100. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 700, 900 and 1100. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 700, 900 and 1100. This apparatus may be, for example, an apparatus of a UE (such as a wireless device 202 that is a UE, as described herein).

Embodiments contemplated herein include a signal as described in or related to one or more elements of the method 700, 900 and 1100.

Embodiments contemplated herein include a computer program or computer program product comprising instructions, wherein execution of the program by a processor is to cause the processor to carry out one or more elements of the method 700, 900 and 1100. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 800, 1000 or 1200. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 800, 1000 and 1200. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 800, 1000 and 1200. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 800, 1000 or 1200. This apparatus may be, for example, an apparatus of a base station (such as a network device 218 that is a base station, as described herein).

Embodiments contemplated herein include a signal as described in or related to one or more elements of the method 800, 1000 or 1200.

Embodiments contemplated herein include a computer program or computer program product comprising instructions, wherein execution of the program by a processing element is to cause the processing element to carry out one or more elements of the method 800, 1000 and 1200. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the UE is configured to perform operations comprising:
receiving from a base station a trigger for triggering reporting of CSI during a RACH procedure; and
reporting, to the base station, CSI during the RACH procedure.

2. The UE of claim 1, wherein the reporting, to the base station, CSI during the RACH procedure further comprises one of the following:
reporting CSI in Msg3 for a 4-step RACH procedure;
reporting CSI in MsgA for a 2-step RACH procedure; or
reporting CSI in Msg3 during a fallback operation for a 2-step RACH procedure.

3. The UE of claim 1, wherein the trigger is included in one of the following:
(i) System Information (S1) or RRC configuration;
(ii) MAC CE; or
(iii) DCI.

4. The UE of claim 1, wherein the operations further comprise:
receiving from the base station, PRACH resource configuration in S1 or RRC configuration, the PRACH resource configuration includes available PRACH resources from a PRACH resource pool associated with supporting of the reporting of CSI during a RACH procedure; and
sending communication to the base station using a PRACH resource from the available PRACH resources.

5. The UE of claim 1, wherein the operations further comprise:
receiving, from the base station, CSI report configuration, wherein the CSI report configuration comprises at least one of the following: (i) reference signal configuration used for CSI measurement, or (ii) report quantity configuration for CSI reporting; and
performing CSI measurement and CSI reporting based on the CSI report configuration.

6. The UE of claim 5, wherein at least a part of the CSI report configuration is included in one of the following:
(i) System Information (S1) or RRC configuration;
(ii) MAC CE; or
(iii) DCI.

7. The UE of claim 1, wherein a reference signal for CSI measurement is either SSB or CSI-RS.

8. The UE of claim 1, wherein report quantity configuration for CSI reporting includes at least one of the following:
(i) L1-RSRP;
(ii) L1-SINR; or
(iii) cri-RI-PMI-CQI, cri-RI-LI-PMI-CQI, cri-RI-il, cri-RI-il-CQI or cri-RI-CQI.

9. The UE of claim 1, wherein the UE performs CSI measurement and CSI reporting during the RACH procedure based on timeline constrains, wherein the timeline constrains comprise a first minimum time required for the UE to measure the CSI and generate a CSI report.

10. The UE of claim 9, wherein the timeline constrains further comprise a second minimum time required for the UE to finish processing of the trigger for the CSI report.

11. A method, comprising:
by a user equipment (UE),
receiving from a base station a trigger for triggering reporting of CSI during a RACH procedure; and
reporting, to the base station, CSI during the RACH procedure.

12. The method of claim 11, wherein the reporting, to the base station, CSI during the RACH procedure further comprises one of the following:
reporting CSI in Msg3 for a 4-step RACH procedure;
reporting CSI in MsgA for a 2-step RACH procedure; or
reporting CSI in Msg3 during a fallback operation for a 2-step RACH procedure.

13. The method of claim 11,
wherein the trigger is included in one of the following:
(i) System Information (S1) or RRC configuration;
(ii) MAC CE; or
(iii) DCI.

14-15. (canceled)

16. A base station (BS), comprising:
at least one antenna;
at least one radio coupled to the at least one antenna; and
a processor coupled to the at least one radio;
wherein the BS is configured to perform operations comprising:
sending to a user equipment (UE) a trigger for triggering reporting of CSI during a RACH procedure; and
receiving CSI reported by the UE during the RACH procedure.

17. The BS of claim 16, wherein the receiving CSI reported by the UE during the RACH procedure further comprises one of the following:
receiving CSI reported in Msg3 for a 4-step RACH procedure;
receiving CSI reported in MsgA for a 2-step RACH procedure; or
receiving CSI reported in Msg3 during a fallback operation for a 2-step RACH procedure.

18. The BS of claim 16, wherein the trigger is included in one of the following:
(i) System Information (S1) or RRC configuration;
(ii) MAC CE; or
(iii) DCI.

19. The BS of claim 16, wherein the operations further comprise:
sending, to the UE, PRACH resource configuration in S1 or RRC configuration, the PRACH resource configuration includes available PRACH resources from a PRACH resource pool associated with supporting of the reporting of CSI during a RACH procedure; and
receiving communication sent from the UE using a PRACH resource from the available PRACH resources.

20. The BS of claim 16, wherein the operations further comprise:
sending, to the UE, CSI report configuration, wherein the CSI report configuration comprises at least one of the following: (i) reference signals configuration used for CSI measurement; or (ii) report quantity configuration for CSI reporting,
wherein the received CSI is obtained by the UE based on the CSI report configuration.

21. The BS of claim 16, wherein at least a part of the CSI report configuration is included in one of the following:
(i) System Information (S1) or RRC configuration;
(ii) MAC CE; or
(iii) DCI.

22. The BS of claim 16, wherein a reference signal for CSI measurement is either SSB or CSI-RS.

23-26. (canceled)
